(19) United States
(12) Patent Application Publication
(10) Pub. No.: US 2011/0120387 A1
(43) Pub. Date: May 26, 2011

(54) ANIMAL GUIDE

(75) Inventor: Waldemar Warkentin, Bad Oeynhausen (DE)

(73) Assignee: PATENTOPET GMBH & CO. KG, Doerentrup (DE)

(21) Appl. No.: 12/992,639

(22) PCT Filed: Jul. 14, 2009
(86) PCT No.: PCT/EP09/58985

§ 371 Date: Feb. 2, 2011

(30) Foreign Application Priority Data
Jul. 23, 2008 (DE) 10 2008 034 381.1
Sep. 2, 2008 (US) 61093528
Mar. 10, 2009 (DE) 10 2009 011 926.4

(51) Int. Cl. A01K 29/00; A01K 27/00

(52) U.S. Cl. 119/719; 119/792

(57) ABSTRACT

An animal guide device, such as a leash assembly, includes a body part that can be placed on the body of the animal, for example a collar, a harness or a head piece, and a leash that can be attached to the body part. The pulling force exerted by the animal is determined by way of an in-line force measuring device. To limit the amount of pulling force exerted on the person leading the animal a signal generator or a tone generator is activated when a given pulling force is exceeded. The generator(s) can generate sound waves that are either only detected by the animal or are detected by the animal and by the person leading the animal. Alternatively, a spraying device can be activated through the signal generator. The animal guide device according to the invention is designed specifically for domestic animals, preferably for dogs.

The invention relates to an animal guide having a body part which can be placed on the body of the animal and a leash which can be attached to the body part.

The animal guide in question is designed for animals, in particular dogs. Such an animal guide is generally also referred to as a guide leash. If the animal guide is used for domestic animals, it is generally referred to as a dog leash. However, the animal guide in question cannot only be used for domestic animals but can also be used for large animals, for example for horses, cattle, bulls and the like. The body part which can be placed on the body of the animal may be a collar, a harness or, in the case of large animals, a head piece. The leash which can be attached to the body part may be permanently or releasably connected to the body part. The other end of the leash may be, for example, a loop in order to securely hold the leash.

It is generally known that dogs, in particular, tend to want to run faster than the speed at which the person guiding the dog is walking, running or cycling. As a result, unpleasant forces are transmitted to the person guiding the animal via the leash.

The invention is based on the object of configuring an animal guide of the type described in more detail at the outset in such a manner that this guiding process is facilitated or becomes more pleasant for the person guiding the animal.

The stated object is achieved by a force measuring device for activating a signal generator. An animal guide for domestic animals is preferably envisaged.

The force measuring device respectively determines the tensile force exerted by the animal on the animal guide. If a particular value is exceeded, the signal generator is activated, such that, with appropriate training of the animal, a response is given such that the speed is reduced, thus also reducing the tensile force.

The force measuring device can be designed in various ways. For example, provision is made for the force measuring device to be in the form of a load cell which records the tensile force. This load cell can operate in an electronically based manner, in which case there is then a need for a voltage source, for example in the form of a battery or a rechargeable battery. However, it may also be a purely mechanical measuring device, preferably in the form of a tension spring which lengthens as the tensile force increases, the signal generator being activated in the case of a particular length. It would then be conceivable for the signal generator to be arranged inside the tension spring. The force measuring device may also be a strain gauge.

The signal generator is designed to generate acoustic waves which can be perceived by animals but cannot be perceived by the people guiding the animals. However, it is also possible for tones to be generated which can be perceived by the animals and by people.

One preferred embodiment therefore provides for the signal generator to be a generator which generates ultrasonic waves and/or a tone generator and/or a vibrator and/or a transmitter which generates electrical signals, preferably shock signals.

An alternative embodiment provides for the force measuring device to be operatively connected to a spraying device. This spraying device could be a spray which influences the animal's behavior. However, it should be safe; the use of a citrus spray is preferably envisaged. The force measuring device and the signal generator can be arranged inside the animal guide in various ways. Provision is also made for the leash to be equipped with the force measuring device and for the body part to have the signal or tone generator. The force measuring device could thus be arranged, for example, on the snap hook of the leash or on the D-ring of the collar. The converse situation is also conceivable, that is to say the leash is equipped with the signal or tone generator and the body part has force measuring devices. It is also conceivable for the force measuring device and the signal generator or tone generator to be separate from one another and to be in the form of an adapter part. Such an adapter part can be easily mounted and fastened.

So that handling is extremely simple for the user, another refinement also provides for the force measuring device and the signal generator to form a structural unit, which force measuring device and signal generator are either strung together or are mounted in a common housing. With an embodiment mentioned above, it is then conceivable for the force measuring device and the signal generator to be designed as a retrofit kit so that existing leashes can be retrofitted therewith. It is advantageous when the structural unit or the housing is provided, on the opposite sides, with suspension elements which are preferably in the form of snap hooks.

Another refinement also provides for the frequency of the ultrasonic waves generated by the signal generator or the volume of the tones to be changed using a control device. This results in the possibility of being able to gear the ultrasonic signals to the dog's behavior.

This control device can have different designs. Provision is thus made for this control device to be in the form of a separate component or to be integrated in the leash or in the body part. However, provision is preferably made for it to be a separate component or to be integrated in the leash. If it is a separate component, it can be operated by the person guiding the dog in the sense of a remote control. If it is integrated in the leash, it may be integrated at such a location that the person guiding the dog can operate the control device. However, it is alternatively also possible for the control device to be controlled by the respective tensile force applied by the dog. In this case, the device could be changed into a basic setting depending on the size and/or strength of a dog, such that the frequency or pitch of the tones is then changed.

If the control device is operated manually, provision is made for said device to be equipped with an actuator for changing the volume, preferably in the form of a small adjusting wheel, a slide switch, a microswitch or the like.

In particular, if the control device is operated manually, it is advantageous if said device is equipped with an optical display, preferably in the form of a plurality of light-emitting diodes, for displaying the respective volume or frequency. This display could then be designed in such a manner that the number of light-emitting diodes which light up is increased with increasing tensile force.

Provision is also made for the components which form the control device to be installed in a housing. This housing is preferably formed from two housing shells or from a box-like housing part and a cover.

If the control device is operated manually, another refinement also provides for the housing to be equipped, on the opposite narrow sides, with two suspension elements, preferably in the form of eyelets. These eyelets allow the control device to be picked up but also allow the control device to be integrated in the leash with appropriate mating parts.

Another embodiment also provides for a suspension apparatus to be provided on the leash or on the body part in such a manner that a trigger preferably arranged on the structural unit formed from the signal generator and the force measuring device can be activated by mechanically moving the tensile force.

It is not necessary for the force measuring device and the signal generator to be connected to the leash and to the body part, rather the structural unit formed from the signal generator and the force measuring device or else said components each individually is/are used to guide the animal. This applies, in particular, to the rearing of an animal.

The invention is explained in yet more detail using the accompanying drawing, in which:

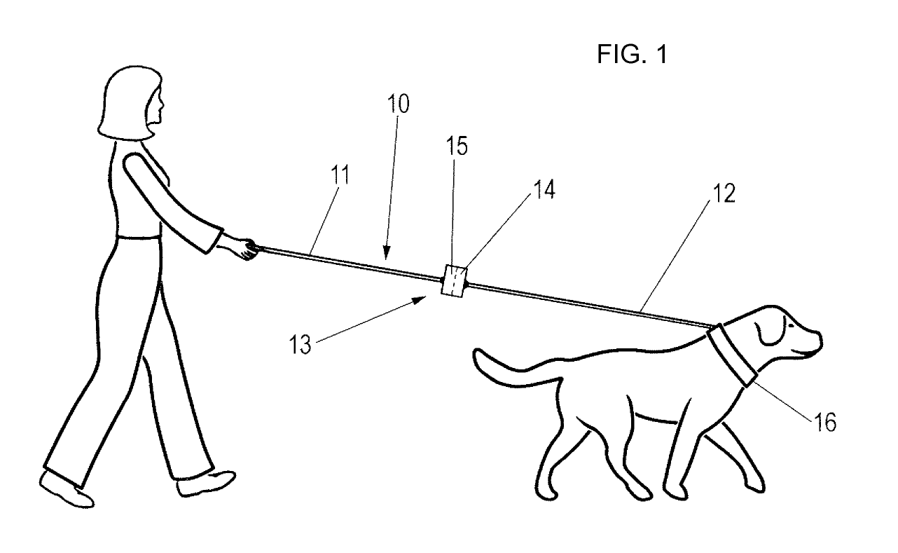

FIG. 1 shows a person guiding a dog using the animal guide according to the invention

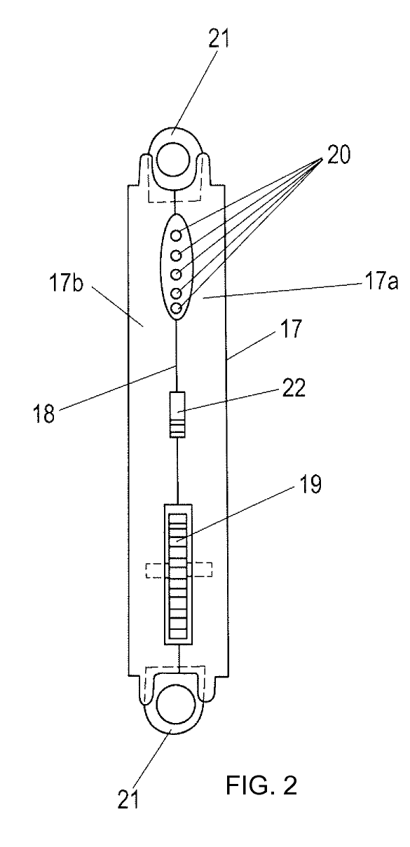

FIG. 2 shows a plan view of the control device.

FIG. 1 is intended to illustrate that a person is walking a dog using the animal guide 10 according to the invention. In the exemplary embodiment illustrated, this animal guide 10 consists of a dog leash which is formed from two parts 11, 12. The two parts 11, 12 are connected using a structural unit 13 which consists of a force measuring device 14 (not explained in any more detail) and a signal generator 15.

When a particular tensile force is exceeded, the force measuring device 14 generates a signal for activating the signal generator 15. However, it is also alternatively possible for the signal generator 15 to be switched by the force measuring device 14. The waves emitted by the signal generator 15 are preferably in a frequency range which can still be perceived by animals but can no longer be perceived by people. These frequencies are in the ultrasonic range.

In the exemplary embodiment illustrated, the dog leash formed from the parts 11, 12 is attached to a collar 16. Contrary to this illustration, a body part in the form of a harness or head piece could also be used instead of the collar 16. With appropriate training of the animal or else by habit, the animal will reduce the tensile force if it perceives the ultrasonic waves.

FIG. 2 shows a plan view of the control device for controlling the frequency level of the signal generator or the pitch of the signals. The components which form the control device are installed in a housing 17. The housing consists of the two housing shells 17a and 17b, as indicated by the joint 18. The components of the control device which are known per se are installed in the housing 17. The mutual assignment and the description of these components are dispensed with since they belong to the general prior art. As FIG. 2 shows, an actuator 19 is installed in the center in order to influence the frequency level or the pitch of the signals. In the exemplary embodiment illustrated, this actuator is a small adjusting wheel which is knurled on the circumferential side. In a manner which is not illustrated, the actuator may be a slide switch, a microswitch or another actuator used in control technology. In order to make the frequency level or the pitch of the signals visible to the user, a number of light-emitting diodes 20 are installed in the housing 17. The number of light-emitting diodes 20 which light up depends on the frequency level or pitch of the signals. For the purpose of optimal handling, the housing 17 is square or round or oval, the length being considerably greater than the width. A suspension element in the form of an eyelet 21 is installed on each of the two narrow sides opposite one another. These eyelets do not cause annoyance when the person guiding the dog picks up the control device but it is also possible for the control device to be integrated in the leash. Another switch 22 is also installed in the housing 17 in order to switch the control device on and off.

The invention is not restricted to the exemplary embodiment illustrated. It is important that signals are generated when a particular tensile force acting on the animal guide 10 is exceeded, which signals can be perceived at least by the animal but preferably cannot be perceived by the person guiding the animal.

1-20. (canceled)

21. An animal guide device for leading and training an animal, comprising:
a body part to be placed on the body of the animal;
a leash attached to said body part, wherein a given pulling force exerted by the animal on the leash is transferred to a distal end of said leash;
a force measuring device disposed in-line between said body part and said distal end of said leash;
a signal generator connected to and activated by said force measuring device, said signal generator being configured to generate a first signal upon being activated when the animal exerts a minimum pulling force on the leash and to generate a second signal, different from the first signal, when the animal exerts a pulling force greater than the minimum pulling force.

22. The animal guide device according to claim 21, wherein said force measuring device is a load cell configured to record a tensile force.

23. The animal guide device according to claim 21, wherein said force measuring device is a tension spring or a strain gauge.

24. The animal guide device according to claim 21, wherein said signal generator is an ultrasound generator configured to generate ultrasonic waves of mutually different frequencies or mutually different intensities.

25. The animal guide device according to claim 21, wherein said force measuring device is carried in-line on said leash and said signal generator is disposed on said body part.

26. The animal guide device according to claim 21, wherein said force measuring device is disposed on said body part and said signal generator is disposed on said leash.

27. The animal guide device according to claim 21, wherein said force measuring device and said signal generator are commonly mounted in a structural unit.

28. The animal guide device according to claim 27, wherein said structural unit including said force measuring device and said signal generator are configured as a retrofit kit to be connected in-line between a leash and an animal collar or harness.

29. The animal guide device according to claim 21, which further comprises a control device for altering a frequency of the ultrasonic waves generated by said signal generator or an intensity of the signals.

30. The animal guide device according to claim 29, wherein said control device includes a manual adjustment actuator for changing a volume of an output signal of said signal generator.

31. The animal guide device according to claim 29, wherein said control device includes an optical display for displaying a current volume of the signal generator.

32. The animal guide device according to claim 29, wherein said control device is automatically controlled on the basis of a tensile force acting between the animal and the distal end of said leash.

33. The animal guide device according to claim 21, wherein said signal generator is configured to vary at least one of a frequency and an intensity of an output signal continuously in dependence on a magnitude of the pulling force.

34. The animal guide device according to claim 21, wherein said control device, said signal generator, and said force measuring device are commonly arranged in a housing and said housing is provided with respective suspension elements on opposite sides thereof.

35. The animal guide device according to claim 21, which comprises a suspension apparatus disposed on said leash or on said body part such that a trigger is activatable by mechanically moving the tensile force.

36. An animal training device, comprising:
a housing formed with a first suspension element to be connected to a collar or a harness on an animal and a second suspension element to be connected to a leash;
wherein, when said housing is connected between the leash and the animal, the animal is guided with the leash and a given pulling force exerted by the animal is transferred by way of said housing;
a force measuring device disposed in said housing in-line between said first suspension element and said second suspension element for measuring the pulling force acting between the leash and the animal;
a signal generator connected to and activated by said force measuring device, said signal generator being configured to generate a first signal upon being activated when the animal exerts a minimum pulling force on the leash and to generate a second signal, different from the first signal, when the animal exerts a pulling force greater than the minimum pulling force.

37. The animal training device according to claim 36, wherein said first and second suspension elements are disposed on mutually opposite sides of said housing and said signal generator is oriented to issue a signal in a direction of the animal.

38. The animal training device according to claim 36, wherein said said signal generator is configured to issue a signal of increasing intensity or increasing frequency in dependence on an increase of the pulling force exerted by the animal on the leash.
